(19) United States
(12) Patent Application Publication
(10) Pub. No.: US 2016/0061415 A1
(43) Pub. Date: Mar. 3, 2016

(54) THREE-DIMENSIONAL IMAGE DISPLAYING DEVICE AND THREE-DIMENSIONAL IMAGE DISPLAY

(71) Applicant: Shenzhen China Star Optoelectronics Technology Co., Ltd, Guangdong (CN)

(72) Inventor: Jianhong CHEN, GUANGDONG (CN)

(21) Appl. No.: 14/402,361

(22) PCT Filed: Sep. 17, 2014
(86) PCT No.: PCT/CN2014/086682

§ 371 Date: Aug. 25, 2015

(30) Foreign Application Priority Data
Aug. 27, 2014 (CN) 201410429154.2

(51) Int. Cl. F21V 7/22; F21V 7/00

(52) U.S. Cl. CPC F21V 7/22; F21V 7/0091

(57) ABSTRACT

A three-dimensional image displaying device is provided. The three-dimensional image displaying device includes an element image array, a backlight source, and a pinhole array. The light reinforcing structure is disposed on the back side of the pinhole array for increasing the light extracting rate of the pinhole array. The light extracting rate of the pinhole array is raised by disposing the light reinforcing structure on the back side of the pinhole array, and therefore the display brightness of the three-dimensional image displaying device is increased.

### FIELD OF THE INVENTION

The present invention relates to a display field and in particular to a three-dimensional image displaying device and a three-dimensional image display.

### BACKGROUND OF THE INVENTION

With the development of technology, a three-dimensional image displaying device for effectively and realistically displaying images is required in a variety of fields, such as entertainment, gaming, advertising, health care, education, military, etc. Therefore, the developers of displaying devices have proposed various technologies for displaying three-dimensional (3D) images, and various three-dimensional image displaying devices have been commercialized.

FIG. 1 is a schematic structural view of a conventional three-dimensional image displaying device, which comprises a backlight source 11, a pinhole array 12, and an element image array 13 configured by a liquid crystal display panel.

The element image array 13 is used to capture or generate three-dimensional scene information, such as the number “3” and the letter “D” in the figure in the three-dimensional image displaying device. Afterward, a point light source array is formed from the backlight source 11 and the pinhole array 12. Each point light source of the point light source arrays has a certain emission angle. The three-dimensional scene information in the element image array 13 is reconstructed through the point light source array by irradiating the pixel cells of the element image array 13. Users can view the three-dimensional images with naked eyes.

The three-dimensional image display method provides continuous viewing angles, and the structure of the three-dimensional image displaying device is simple. However, since the pinholes of the pinhole array 12 are small, the light emitted from the backlight source directly through the pinholes is little, and after multiple reflections, a part of energy of the emitted light through the pinholes is lost due to the reflections. Therefore, the display brightness of the three-dimensional image displaying device is low, or the production cost of the backlight source is high.

Therefore, it is necessary to provide a three-dimensional image displaying device and a three-dimensional image display to resolve the problem of the prior art.

### SUMMARY OF THE INVENTION

A primary object of the present invention is to provide a three-dimensional image displaying device and a three-dimensional image display with high display brightness to resolve the technical problem of the low display brightness or the high production cost of the conventional three-dimensional image displaying device and three-dimensional image display.

To solve the above problems, the present invention provides the technical solution as follows:
An embodiment of the present invention provides a three-dimensional image displaying device, comprising:
   an element image array including a plurality of pixel cells for displaying three-dimensional scene information;
   a backlight source for providing the element image array with a display light source to reconstruct a three-dimensional scene in a display area; and
   a pinhole array including a plurality of pinholes for transforming light emitted from the backlight source into scattered light of a point light source;
   wherein a light reinforcing structure is disposed on a back side of the pinhole array for increasing a light extracting rate of the pinhole array, the back side of the pinhole array is a side of the pinhole array facing the backlight source, the light reinforcing structure is a reflective film disposed on the back side of the pinhole array, and the reflective film is a metallic high-reflective film or a bubble polymer film disposed in a non-pinhole area of the back side of the pinhole array.

In the three-dimensional image displaying device of the present invention, the reflective film is disposed near a pinhole area on the back side of the pinhole array.

An embodiment of the present invention provides a three-dimensional image displaying device, comprising:
a three-dimensional image displaying device, comprising:
   an element image array including a plurality of pixel cells for displaying three-dimensional scene information;
   a backlight source for providing the element image array with a display light source to reconstruct a three-dimensional scene in a display area; and
   a pinhole array including a plurality of pinholes for transforming light emitted from the backlight source into scattered light of a point light source;
   wherein a light reinforcing structure is disposed on a back side of the pinhole array for increasing a light extracting rate of the pinhole array, and the back side of the pinhole array is a side of the pinhole array facing the backlight source.

In the three-dimensional image displaying device of the present invention, the light reinforcing structure is a reflective film disposed on the back side of the pinhole array.

In the three-dimensional image displaying device of the present invention, the reflective film is disposed in a non-pinhole area of the back side of the pinhole array.

In the three-dimensional image displaying device of the present invention, the reflective film is disposed near a pinhole area on the back side of the pinhole array.

In the three-dimensional image displaying device of the present invention, the reflective film is a metallic high-reflective film or a bubble polymer film.

In the three-dimensional image displaying device of the present invention, the light reinforcing structure is a structure with a high refractive index disposed on the back side of the pinhole array.

In the three-dimensional image displaying device of the present invention, the structure with the high refractive index is disposed in the pinhole area and the non-pinhole area near the pinhole area of the back side of the pinhole array.

In the three-dimensional image displaying device of the present invention, a width of a side of the structure with the high refractive index near the pinhole array is greater than a width of a side of the structure with the high refractive index near the backlight source.

In the three-dimensional image displaying device of the present invention, the light reinforcing structure comprises the reflective film and a structure with a high refractive index disposed on the back side of the pinhole array, the reflective film is disposed in a non-pinhole area of the back side of the pinhole array, the structure with the high refractive index is disposed in a pinhole area and the non-pinhole area near the pinhole area of the back side of the pinhole array.

An embodiment of the present invention provides a three-dimensional image display, comprising:
an element image array driving circuit for driving an element image array;
a backlight source driving circuit for driving a backlight source; and
a three-dimensional image displaying device, comprising:
   the element image array including a plurality of pixel cells for displaying three-dimensional scene information;
   the backlight source for providing the element image array with a display light source to reconstruct a three-dimensional scene in a display area; and
   a pinhole array including a plurality of pinholes for transforming light emitted from the backlight source into scattered light of a point light source;
   wherein a light reinforcing structure is disposed on a back side of the pinhole array for increasing a light extracting rate of the pinhole array, and the back side of the pinhole array is a side of the pinhole array facing the backlight source.

In the three-dimensional image display of the present invention, the light reinforcing structure is a reflective film disposed on the back side of the pinhole array.

In the three-dimensional image display of the present invention, the reflective film is disposed in a non-pinhole area of the back side of the pinhole array.

In the three-dimensional image display of the present invention, the reflective film is disposed near a pinhole area on the back side of the pinhole array.

In the three-dimensional image display of the present invention, the reflective film is a metallic high-reflective film or a bubble polymer film.

In the three-dimensional image display of the present invention, the light reinforcing structure is a structure with a high refractive index disposed on the back side of the pinhole array.

In the three-dimensional image display of the present invention, the structure with the high refractive index is disposed in the pinhole area and the non-pinhole area near the pinhole area of the back side of the pinhole array.

In the three-dimensional image display of the present invention, a width of a side of the structure with the high refractive index near the pinhole array is greater than a width of a side of the structure with the high refractive index near the backlight source.

In the three-dimensional image display of the present invention, the light reinforcing structure comprises the reflective film and a structure with a high refractive index disposed on the back side of the pinhole array; the reflective film is disposed in a non-pinhole area of the back side of the pinhole array, the structure with the high refractive index is disposed in a pinhole area and the non-pinhole area near the pinhole area of the back side of the pinhole array.

Compared to the conventional three-dimensional image displaying device and three-dimensional image display, the three-dimensional image displaying device or the three-dimensional image display of the present invention raises the light extracting rate of the pinhole array, and therefore increases the display brightness of the three-dimensional image displaying device by disposing the light reinforcing structure on the back side of the pinhole array. The technical problem of the low display brightness or the high production cost of the conventional three-dimensional image displaying device and three-dimensional image display is solved.

To make the foregoing contents of the present invention more clearly understood, the preferred embodiments are described in detail below in conjunction with accompanying drawings.

### BRIEF DESCRIPTION OF THE DRAWINGS

FIG. 1 is a structural schematic diagram of a conventional three-dimensional image displaying device.

FIG. 2 is a structural block diagram of a three-dimensional image displaying device in accordance with a preferred embodiment of the present invention.

FIG. 3 is a structural schematic diagram of a three-dimensional image displaying device in accordance with a first preferred embodiment of the present invention.

FIG. 4 is a structural schematic diagram of a three-dimensional image displaying device in accordance with a second preferred embodiment of the present invention.

FIG. 5 is a structural schematic diagram of a three-dimensional image displaying device in accordance with a third preferred embodiment of the present invention.

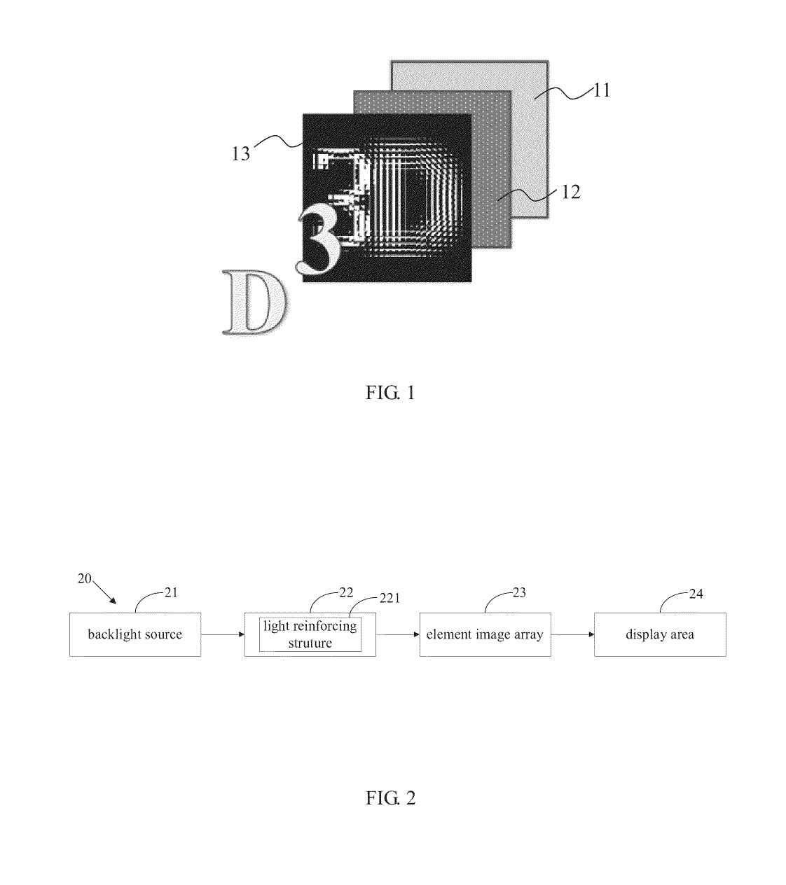

### DETAILED DESCRIPTION OF THE PREFERRED EMBODIMENTS

The following description of the embodiments with reference to the accompanying drawings is used to illustrate particular embodiments of the present invention. The directional terms referred in the present invention, such as “upper”, “lower”, “front”, “after”, “left”, “right”, “inner”, “outer”, “side surface”, etc. are only directions with regard to the accompanying drawings. Therefore, the directional terms used for describing and illustrating the present invention are not intended to limit the present invention.

In the drawings, units with similar structures are indicated by the same reference number.

Please refer to FIG. 2, which is a structural block diagram of a three-dimensional image displaying device in accordance with a preferred embodiment of the present invention. The three-dimensional image displaying device 20 of the preferred embodiment includes an element image array 23, a backlight source 21, and a pinhole array 22. The element image array 23 includes a plurality of pixel cells for displaying three-dimensional scene information. The backlight source 21 is used for providing the element image array with display light sources to reconstruct a three-dimensional scene in a display area. The pinhole array 22 includes a plurality of pinholes for transforming light emitted from the backlight source into scattered light of point light sources.

In the preferred embodiment, a light reinforcing structure 221 is disposed on a back side of the pinhole array 22 for increasing a light extracting rate of the pinhole array 22, and the back side of the pinhole array 22 is a side of the pinhole array 22 facing the backlight source 21.

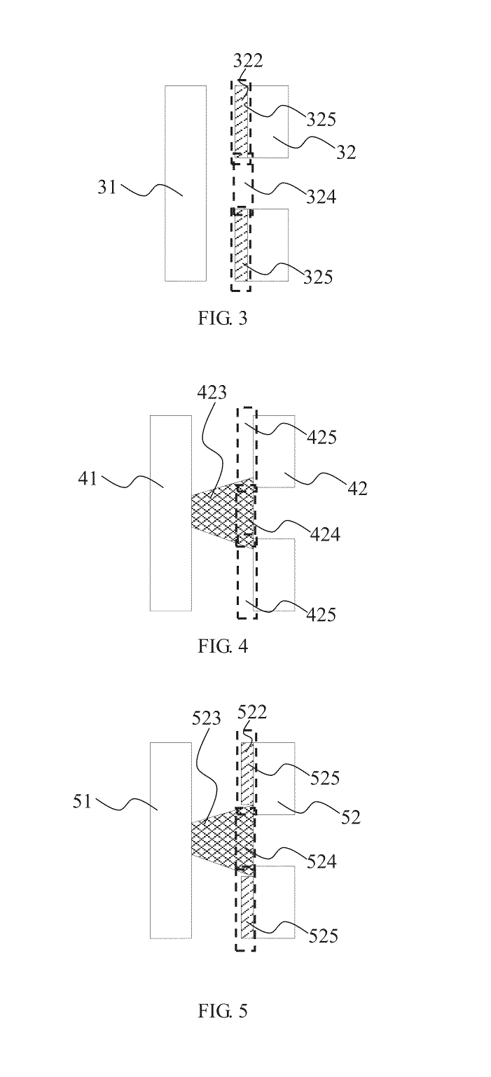

Please refer to FIG. 3, which is a structural schematic diagram of a three-dimensional image displaying device in accordance with a first preferred embodiment of the present invention. In the preferred embodiment, the light reinforcing structure is a reflective film 322 disposed on the back side of the pinhole array 32. The reflective film 322 is disposed on the non-pinhole area 325 near the pinhole area 324 of the back side of the pinhole array 32, so that the reflective film 322 can conduct total reflection on the light near the pinholes on the pinhole array 32 to reduce the loss of the emitted light in reflection, and to increase the light extracting rate of the pinhole array 32. The reflective film 322 preferably is a metallic high-reflective film (such as silver, aluminum, chromium, and other metal films), or a bubble polymer film. The metallic high-reflective film can directly and efficiently conduct total reflection on the light, and the light extracting rate of the pinhole array 32 can be increased effectively. The bubble polymer film conducts total reflection on the light via bubbles in the polymer. Although the light extracting rate of the pinhole array 32 is only increased to a small extent, the bubble polymer film has a low cost and can be mounted easily.

In the preferred embodiment of the three-dimensional image displaying device, the backlight source 31 provides the element image array with display light sources through the pinholes of the pinholes array 32 in use. A part of the light is emitted from the backlight source 31, through the pinholes, directly onto the element image array. Another part of the light emitted from the backlight source 31 is incident onto the reflective film 322 on the back side of the pinhole array 32. The light reflected by the reflective film is then reflected by the backlight source 31, thereby increasing the light emitted through the pinholes of the pinhole array 32, and raising the light extracting rate of the pinhole array 32.

If the reflective film 322 is a metallic high-reflective film, the metallic high-reflective film directly conducts reflection on the light which is emitted onto the metallic high-reflective film. If the reflective film 322 is a bubble polymer film, since a large number of air bubbles are disposed in the bubble polymer film, when the light is emitted from the polymer with a high refractive index to air bubbles with a low refractive index, total reflection occurs easily, thereby conducting reflection on most of the light emitted to the bubble polymer film.

In the preferred embodiment of the three-dimensional image displaying device, the light extracting rate of the pinhole array is increased by disposing the reflective film on the back side of the pinhole array, thereby improving the display brightness of the three-dimensional image displaying device.

Please refer to FIG. 4, which is a structural schematic diagram of a three-dimensional image displaying device in accordance with a second preferred embodiment of the present invention. In the preferred embodiment, the light reinforcing structure is a structure with a high refractive index 423 disposed on the back side of the pinhole array 42. The structure with the high refractive index 423 is disposed on the pinhole area 424 of the back side of the pinhole array 42 and on the non-pinhole area 425 near the pinhole area 424.

As shown in FIG. 4, the width of the side of the structure with the high refractive index 221 near the pinhole array 42 is greater than the width of the side near the backlight source 41.

Since the structure with the high refractive index 423 has a greater refractive index than the refractive index of air, total reflection very easily occurs to the light emitted by the backlight source 41 on an interface between the structure with the high refractive index 423 and air. Meanwhile, the direction the interface between the structure with the high refractive index 423 and air (e.g. the width of the side of the structure with the high refractive index 221 near the pinhole array 42 is greater than the width of the side near the backlight source 41), allows the light emitted from the backlight source 41 to be incident on the interface at a great angle, thereby making most of the light in the structure with the high refractive index 421 to be emitted through the pinholes, and increasing the light extracting rate of the pinhole array 42.

In the preferred embodiment of the three-dimensional image displaying device, the backlight source 41 provides the element image array with display light sources through the pinholes of the pinholes array 42 in use. A part of the light is emitted from the backlight source 41, through the structure with the high-refractive index and the pinholes, directly onto the element image array. After total reflection occurs to another part of the light emitted through the structure with the high refractive index 423, the part of the light is emitted onto the element image array through the pinholes, thereby increasing the light emitted through the pinholes of the pinhole array 42, and raising the light extracting rate of the pinhole array 42.

In the preferred embodiment of the three-dimensional image displaying device, the light extracting rate of the pinhole array is increased by disposing the structure with the high refractive index on the back side of the pinhole array, thereby improving the display brightness of the three-dimensional image displaying device.

Please refer to FIG. 5, which is a structural schematic diagram of a three-dimensional image displaying device in accordance with a third preferred embodiment of the present invention. In the preferred embodiment, a light reinforcing structure includes a reflective film 522 and a structure with a high refractive index 523. The reflective film 522 is disposed on the non-pinhole area 525 near the pinhole area 524 of the back side of the pinhole array 52. The structure with the high refractive index 523 is disposed on the pinhole area 524 of the back side of the pinhole array 52 and on the non-pinhole area 525 near the pinhole area 524. The width of the side of the structure with the high refractive index 523 near the pinhole array 52 is greater than the width of the side near the backlight source 41. The reflective film 522 can conduct total reflection on the light near the pinholes on the pinhole array, while the structure with the high refractive index 523 can also conduct total reflection on the light emitted from the backlight source 51, so that most of the light emitted from the backlight source 51 can be emitted through the pinholes, increasing the light extracting rate of the pinhole array 52.

In the preferred embodiment of the three-dimensional image displaying device, the backlight source 51 provides the element image array with display light sources through the pinholes of the pinholes array 52 in use. A part of the light is emitted from the backlight source 51, through the structure with the high-refractive index and the pinholes, directly onto the element image array. After total reflection occurs to another part of the light emitted through the structure with a high refractive index 523, the light emitted is onto the element image array through the pinholes. Meanwhile, the light emitted from the backlight source 21 through the structure with the high refractive index 523 is incident onto the reflective film 522 on the back side of the pinhole array 52. The light reflected by the reflective film 522 is then reflected by the backlight source 51, and can be emitted through the pinholes of the pinhole array 52. Therefore, the light emitted through the pinholes of the pinhole array 52 is increased, and the light extracting rate of the pinhole array 52 is raised.

In the preferred embodiment of the three-dimensional image displaying device, the light extracting rate of the pinhole array is increased by disposing the reflective film and the structure with the high refractive index on the back side of the pinhole array, thereby improving the display brightness of the three-dimensional image displaying device.

An embodiment of the present invention further provides a three-dimensional image display. The three-dimensional image display includes an aforementioned three-dimensional image displaying device, an element image array driving circuit, and a backlight source driving circuit. The element image array driving circuit is used for driving the element image array in the three-dimensional image displaying device. The backlight source driving circuit is used for driving the backlight source in the three-dimensional image displaying device.

The operating principle of the three-dimensional image display of the present invention is the same as or similar to the relative description of the preferred embodiment of the above three-dimensional image displaying device. For the details, please refer to the related description of the above three-dimensional image displaying device of the preferred embodiment.

The three-dimensional image displaying device or the three-dimensional image display of the present invention raises the light extracting rate of the pinhole array, and therefore increases the display brightness of the three-dimensional image displaying device by disposing the light reinforcing structure on the back side of the pinhole array. The technical problem of the low display brightness or the high production cost of the conventional three-dimensional image displaying device and three-dimensional image display is solved.

In summary, although the preferred embodiment of the present invention has been disclosed above, the foregoing preferred embodiment of the present invention is not intended to limit the present invention. A person of ordinary skill in the art, without departing from the spirit and the scope of the invention, may make various modifications and variations. Therefore, the scope of the present invention is defined in the claims.

What is claimed is:

1. A three-dimensional image displaying device comprising:
an element image array including a plurality of pixel cells for displaying three-dimensional scene information;
a backlight source for providing the element image array with a display light source to reconstruct a three-dimensional scene in a display area; and
a pinhole array including a plurality of pinholes for transforming light emitted from the backlight source into scattered light of a point light source;
wherein a light reinforcing structure is disposed on a back side of the pinhole array for increasing a light extracting rate of the pinhole array, the back side of the pinhole array is a side of the pinhole array facing the backlight source, the light reinforcing structure is a reflective film disposed on the back side of the pinhole array, and the reflective film is a metallic high-reflective film or a bubble polymer film disposed in a non-pinhole area of the back side of the pinhole array.

2. The three-dimensional image displaying device as claimed in claim 1, wherein the reflective film is disposed near a pinhole area on the back side of the pinhole array.

3. A three-dimensional image displaying device comprising:
an element image array including a plurality of pixel cells for displaying three-dimensional scene information;
a backlight source for providing the element image array with a display light source to reconstruct a three-dimensional scene in a display area; and
a pinhole array including a plurality of pinholes for transforming light emitted from the backlight source into scattered light of a point light source;
wherein a light reinforcing structure is disposed on a back side of the pinhole array for increasing a light extracting rate of the pinhole array, and the back side of the pinhole array is a side of the pinhole array facing the backlight source.

4. The three-dimensional image displaying device as claimed in claim 3, wherein the light reinforcing structure is a reflective film disposed on the back side of the pinhole array.

5. The three-dimensional image displaying device as claimed in claim 4, wherein the reflective film is disposed in a non-pinhole area of the back side of the pinhole array.

6. The three-dimensional image displaying device as claimed in claim 5, wherein the reflective film is disposed near a pinhole area on the back side of the pinhole array.

7. The three-dimensional image displaying device as claimed in claim 3, wherein the reflective film is a metallic high-reflective film or a bubble polymer film.

8. The three-dimensional image displaying device as claimed in claim 3, wherein the light reinforcing structure is a structure with a high refractive index disposed on the back side of the pinhole array.

9. The three-dimensional image displaying device as claimed in claim 8, wherein the structure with the high refractive index is disposed in the pinhole area and the non-pinhole area near the pinhole area of the back side of the pinhole array.

10. The three-dimensional image displaying device as claimed in claim 9, wherein a width of a side of the structure with the high refractive index near the pinhole array is greater than a width of a side of the structure with the high refractive index near the backlight source.

11. The three-dimensional image displaying device as claimed in claim 3, wherein the light reinforcing structure comprises the reflective film and a structure with a high refractive index disposed on the back side of the pinhole array, the reflective film is disposed in a non-pinhole area of the back side of the pinhole array, the structure with the high refractive index is disposed in a pinhole area and the non-pinhole area near the pinhole area of the back side of the pinhole array.

12. A three-dimensional image display comprising:
an element image array driving circuit for driving an element image array;
a backlight source driving circuit for driving a backlight source; and
a three-dimensional image displaying device comprising:
the element image array including a plurality of pixel cells for displaying three-dimensional scene information;
the backlight source for providing the element image array with a display light source to reconstruct a three-dimensional scene in a display area; and
a pinhole array including a plurality of pinholes for transforming light emitted from the backlight source into scattered light of a point light source;
wherein a light reinforcing structure is disposed on a back side of the pinhole array for increasing a light extracting rate of the pinhole array, and the back side of the pinhole array is a side of the pinhole array facing the backlight source.

13. The three-dimensional image display as claimed in claim 12, wherein the light reinforcing structure is a reflective film disposed on the back side of the pinhole array.

14. The three-dimensional image display as claimed in claim 13, wherein the reflective film is disposed in a non-pinhole area of the back side of the pinhole array.

15. The three-dimensional image display as claimed in claim 14, wherein the reflective film is disposed near a pinhole area on the back side of the pinhole array.

16. The three-dimensional image display as claimed in claim 13, wherein he reflective film is a metallic high-reflective film or a bubble polymer film.

17. The three-dimensional image display as claimed in claim 12, wherein the light reinforcing structure is a structure with a high refractive index disposed on the back side of the pinhole array.

18. The three-dimensional image display as claimed in claim 17, wherein the structure with the high refractive index is disposed in the pinhole area and the non-pinhole area near the pinhole area of the back side of the pinhole array.

19. The three-dimensional image display as claimed in claim 18, wherein a width of a side of the structure with the high refractive index near the pinhole array is greater than a width of a side of the structure with the high refractive index near the backlight source.

20. The three-dimensional image display as claimed in claim 12, wherein the light reinforcing structure comprises the reflective film and a structure with a high refractive index disposed on the back side of the pinhole array, the reflective film is disposed in a non-pinhole area of the back side of the pinhole array, the structure with the high refractive index is disposed in a pinhole area and the non-pinhole area near the pinhole area of the back side of the pinhole array.
